(19) United States
(12) Patent Application Publication
(10) Pub. No.: US 2024/0325896 A1
(43) Pub. Date: Oct. 3, 2024

(54) VEHICLE INTERACTION IN VIRTUAL SCENE

(71) Applicant: Tencent Technology (Shenzhen) Company Limited, Shenzhen (CN)

(72) Inventor: Weijian CUI, Shenzhen (CN)

(73) Assignee: Tencent Technology (Shenzhen) Company Limited, Shenzhen (CN)

(21) Appl. No.: 18/743,394

(22) Filed: Jun. 14, 2024

Related U.S. Application Data
(63) Continuation of application No. PCT/CN2023/103685, filed on Jun. 29, 2023.

(30) Foreign Application Priority Data
Aug. 18, 2022 (CN) 202210991111.8

(51) Int. Cl. A63F 13/533; A63F 13/54; A63F 13/87; G06F 3/0482; G06F 3/0484; G06F 3/0488

(52) U.S. Cl. CPC A63F 13/533; A63F 13/54; A63F 13/87; G06F 3/0482; G06F 3/0484; G06F 3/0488

(57) ABSTRACT

In a vehicle interaction method, a first virtual character is displayed in a virtual scene. The first virtual character is a virtual character controlled by a first terminal, and the virtual scene includes a second virtual character. A vehicle interaction interface is displayed by the first terminal when a vehicle interaction condition is met between the first virtual character and a virtual vehicle. A vehicle interaction message is transmitted to the second virtual character. An animation of a first interaction is displayed by the first terminal between the first virtual character and the virtual vehicle in response to a vehicle trigger operation received by the first terminal on the vehicle interaction interface. Apparatus and non-transitory computer-readable storage medium counterpart embodiments are also contemplated.

### RELATED APPLICATIONS

The present application is a continuation of International Application No. PCT/CN2023/103685, filed on Jun. 29, 2023, which claims priority to Chinese Patent Application No. 202210991111.8, entitled “VEHICLE INTERACTION METHOD AND APPARATUS IN VIRTUAL SCENE, DEVICE, AND COMPUTER PROGRAM PRODUCT”, and filed on Aug. 18, 2022. The entire disclosures of the prior applications are hereby incorporated by reference.

### FIELD OF THE TECHNOLOGY

This application relates to the field of computer technologies, including a vehicle interaction method.

### BACKGROUND OF THE DISCLOSURE

Users can input message content in a message input region within a game interface in a game scene, thereby sending the message content to other players for message interaction. When a player A sends the message content to a player B in a game battle scene, the player B can receive the message content sent by the player A in the game battle scene.

In the related art, when sending a vehicle interaction prompt message to the player B, the player A taps a message control in the interface, so that the message input region is displayed. After the player A inputs the vehicle interaction prompt message in the message input region and taps “send”, the vehicle interaction prompt message sent by the player A can be displayed in a virtual scene interface corresponding to the player B.

However, the foregoing method of sending the vehicle interaction prompt message is cumbersome, which makes it difficult for a player to input the message content while controlling a virtual character to perform interaction action with a virtual vehicle, and takes a long time to input the message content. As a result, a rendering time of a virtual scene picture is excessively long, and data overheads of a computer are increased.

### SUMMARY

Embodiments of this disclosure include a vehicle interaction method, apparatus, and a non-transitory computer-readable storage medium. Examples of technical solutions in the embodiments of this disclosure may be implemented as follows:

An aspect of this disclosure provides a vehicle interaction method, for example, in a vehicle interaction method, a first virtual character is displayed in a virtual scene. The first virtual character is a virtual character controlled by a first terminal, and the virtual scene includes a second virtual character. A vehicle interaction interface is displayed by the first terminal when a vehicle interaction condition is met between the first virtual character and a virtual vehicle. A vehicle interaction message is transmitted to the second virtual character. An animation of a first interaction is displayed by the first terminal between the first virtual character and the virtual vehicle in response to a vehicle trigger operation received by the first terminal on the vehicle interaction interface.

An aspect of this disclosure provides a data processing apparatus, including processing circuitry. The processing circuitry of a first terminal is configured to display a first virtual character in a virtual scene. The first virtual character is a virtual character controlled by the first terminal. The virtual scene includes a second virtual character. The processing circuitry of the first terminal is configured to display a vehicle interaction interface by the first terminal when a vehicle interaction condition is met between the first virtual character and a virtual vehicle. The processing circuitry of the first terminal is configured to transmit a vehicle interaction message to the second virtual character and display an animation of a first interaction by the first terminal between the first virtual character and the virtual vehicle in response to a vehicle trigger operation received by the first terminal on the vehicle interaction interface.

An aspect of this disclosure provides a non-transitory computer-readable storage medium storing instructions which when executed by a processor cause the processor to perform any of the methods of this disclosure.

The embodiments of this disclosure have the following beneficial effects:

On the premise that the first virtual character meets the vehicle interaction condition with the virtual vehicle, for a trigger operation on the displayed vehicle interaction control, on the basis of performing the first interaction action between the first virtual character and the virtual vehicle, the vehicle interaction prompt message is directly transmitted to the second virtual character, so that a player who controls the first virtual character does not need to manually input the vehicle interaction prompt message. The interaction action is performed on the first virtual character and the virtual vehicle while the vehicle interaction prompt message is simultaneously transmitted to the second virtual character with one tap, which improves transmitting efficiency of the message and reduces unnecessary overheads of computer resources.

### BRIEF DESCRIPTION OF THE DRAWINGS

FIG. 1 is a schematic diagram of vehicle interaction in a virtual scene according to an embodiment.

FIG. 2 is a schematic diagram of a message prompt in a virtual scene according to an embodiment.

FIG. 3 is a schematic diagram of an implementation environment according to an embodiment.

FIG. 4 is a flowchart of a vehicle interaction method in a virtual scene according to an embodiment.

FIG. 5 is a schematic diagram of an operation mode of a vehicle interaction control according to an embodiment.

FIG. 6 is a flowchart of simultaneously triggering system determining of activation and taking effect of a message prompt through vehicle interaction according to an embodiment.

FIG. 7 is a schematic diagram of a vehicle interaction control for implementing carrying according to an embodiment.

FIG. 8 is a schematic diagram of triggering display of a message interaction control through a driving operation according to an embodiment.

FIG. 9 is a schematic diagram of activating a message interaction control through a driving operation according to an embodiment.

FIG. 10 is a schematic diagram of triggering a message interaction control to take effect through a driving operation according to an embodiment.

FIG. 11 is a schematic diagram of driving interaction according to an embodiment.

FIG. 12 is a schematic diagram of triggering display of a message interaction control through a riding operation according to an embodiment.

FIG. 13 is a schematic diagram of activating a message interaction control through a riding operation according to an embodiment.

FIG. 14 is a schematic diagram of triggering a message interaction control to take effect through a riding operation according to an embodiment.

FIG. 15 is a schematic diagram of riding interaction according to an embodiment.

FIG. 16 is a flowchart of simultaneously triggering system determining of activation and taking effect of a message prompt through honking interaction according to an embodiment.

FIG. 17 is a schematic diagram of a vehicle interaction control that implements carrying according to an embodiment.

FIG. 18 is a schematic diagram of triggering a message interaction control to take effect through honking according to an embodiment.

FIG. 19 is a flowchart of a vehicle interaction method in a virtual scene according to an embodiment.

FIG. 20 is a flowchart of system determining of activation and taking effect of a response message prompt option according to an embodiment.

FIG. 21 is a schematic diagram of response message interaction according to an embodiment.

FIG. 22 is a schematic diagram of response message interaction according to an embodiment.

FIG. 23 is a structural block diagram of a vehicle interaction apparatus in a virtual scene according to an embodiment.

FIG. 24 is a structural block diagram of a vehicle interaction apparatus module in a virtual scene according to an embodiment.

FIG. 25 is a structural block diagram of a vehicle interaction apparatus in a virtual scene according to an embodiment.

FIG. 26 is a structural block diagram of a computer device according to an embodiment.

### DESCRIPTION OF EMBODIMENTS

In a virtual scene, a user may control a virtual character to interact with other virtual characters in the virtual scene by logging in to an account and creating a virtual character corresponding to the account. For example: the user may chat, perform interaction action, and the like with other virtual characters in the virtual scene by logging in to the account and creating the virtual character.

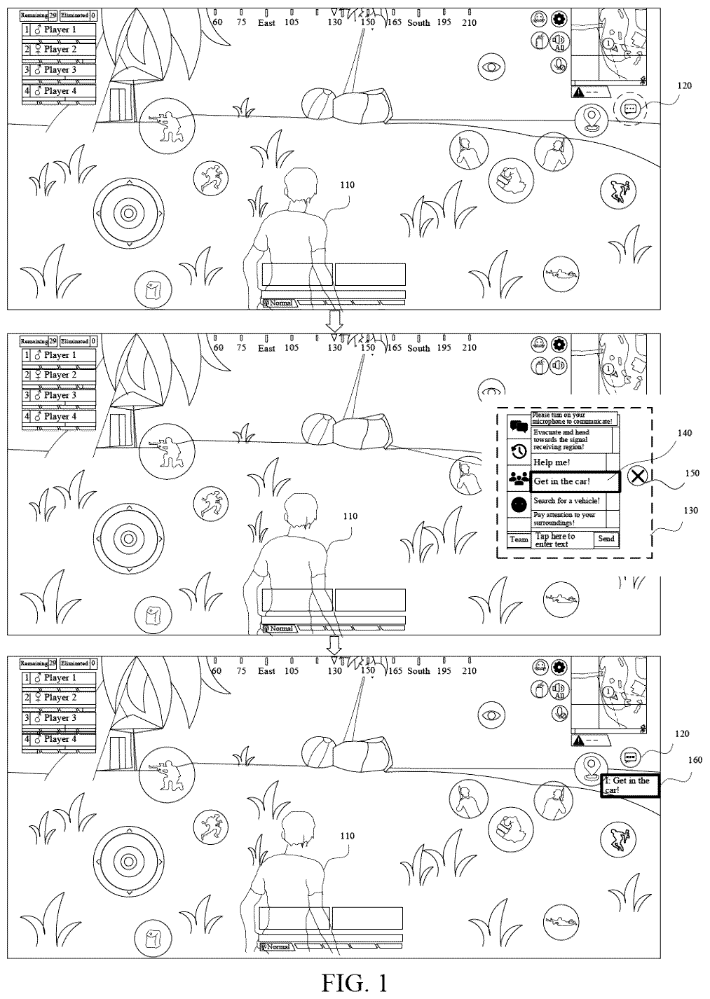

In the related art, an example in which the virtual characters fight a game battle in the virtual scene is used for description. Usually, an operation is performed on a message interaction control displayed in a current terminal picture, to send a relevant prompt message. As shown in FIG. 1, a virtual character 110 currently controlled by a first terminal is displayed in the virtual scene. When the user taps a message interaction control 120, a message option list 130 of the message interaction control is displayed. When the user selects a text message 140, the user taps a close button 150 of the message option list to hide the message option list 130, and a text message content 160 is displayed.

However, a sending manner of the interaction message is only operated through a message interaction control. An operation process is cumbersome and takes a long time, which causes low usage efficiency in prompting the interaction message.

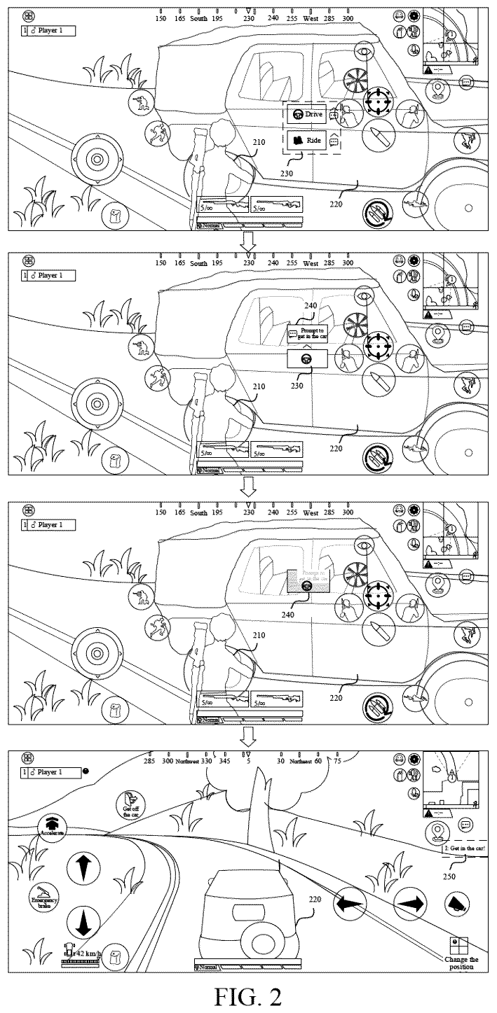

Embodiments of this disclosure provide a vehicle interaction method. When the virtual character is in the virtual scene and the vehicle interaction control is displayed in the current terminal picture, after a vehicle interaction prompt message is triggered when a player triggers the vehicle interaction control, a function of sending the vehicle interaction prompt message to other players is implemented while an interaction function is implemented between the virtual character and a virtual vehicle. As shown in FIG. 2, a virtual character 210 currently controlled by a terminal, and a virtual vehicle 220 are displayed in a virtual social scene. When a vehicle interaction condition is met between the virtual character 210 and the virtual vehicle 220, a vehicle interaction control 230 of the virtual vehicle 220 is displayed. When the user holds and slides up the vehicle interaction control to a vehicle interaction prompt control 240 and releases the vehicle interaction control, an animation of the virtual character 210 switching from a first state of being outside the virtual vehicle 220 to a second state of being inside the virtual vehicle 220 is displayed, and a vehicle interaction prompt message 250 is simultaneously sent and displayed, thereby implementing rapid sending of the vehicle interaction prompt message while interacting with the virtual vehicle, and improving usage efficiency of the prompt message.

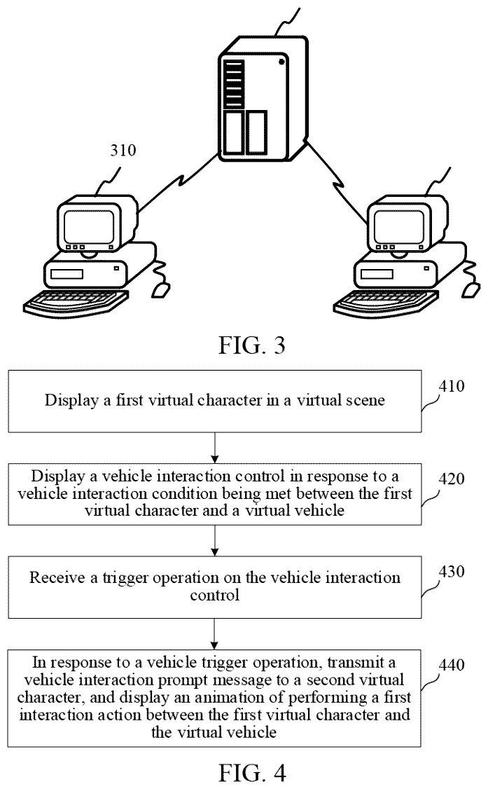

First, an implementation environment in this disclosure is introduced. FIG. 3 is a schematic diagram of an implementation environment according to an embodiment of this disclosure. The implementation environment includes: a terminal 310, a terminal 320, and a server 330.

The terminal 310 and the terminal 320 are installed with an application that can provide a game battle scene. The application may be implemented as a game application, an instant messaging application, a social application, a multimedia application, or the like. This is not limited in the embodiments of this disclosure.

In some embodiments, a first player account is logged in to on the terminal 310, and a second player account is logged in to on the terminal 320. Sending and receiving of communication messages is performed between the first player account and the second player account. In some embodiments, there may be an association relationship between the first player account and the second player account, for example, a friend relationship or a relationship of being in the same team. Alternatively, there may be a stranger relationship between the first player account and the second player account.

The server 330 is configured to interact or transfer the communicate messages between accounts. In some embodiments, the server 330 is further configured to send scene construction data of the game battle scene to the terminal, so that the game battle scene is rendered and displayed in the terminal.

In this embodiment, an example in which the first player account sends the vehicle interaction prompt message to the second player account is used for description. The user selects, on the terminal 310, a message content of the vehicle interaction prompt message that needs to be sent and transfers the message content to the server 330. The server 330 forwards the received vehicle interaction prompt message to the terminal 320 in which the second player account is located, and the terminal 320 prompts a vehicle interaction message based on the received vehicle interaction prompt message.

In this embodiment of this disclosure, a second player character corresponding to the second player account is displayed in the game battle scene. After the terminal 320 receives the vehicle interaction prompt message sent by the first player account, if a second virtual character is outside a vehicle in which a first virtual character is located, a response message prompt option is displayed in a picture of the terminal 320.

The foregoing terminal may be terminal devices in a plurality of forms such as a desktop computer, a portable laptop computer, a mobile phone, a tablet computer, an e-book reader, a Moving Picture Experts Group Audio Layer III (MP3) player, a Moving Picture Experts Group Audio Layer IV (MP4) player, a smart television, or a smart vehicle. This is not limited in the embodiments of this disclosure.

The foregoing server may be implemented as a physical server, or a cloud server, or may be a single server, or a server cluster including a plurality of servers. This is not limited in the embodiments of this disclosure. In some embodiments, the foregoing server may alternatively be implemented as a node in a blockchain system.

FIG. 4 is a flowchart of a vehicle interaction method in a virtual scene according to an embodiment of this disclosure. The method may be independently applied to a terminal or a server, that is, the terminal or the server is independently used as a computer device, or method may be implemented by the server and the terminal in cooperation, that is, the computer device includes both the terminal and the server. In this embodiment, for example, the method is performed in a case that the computer device is implemented as the terminal. As shown in FIG. 4, the method includes the following operations:

Operation 410: Display a first virtual character in a virtual scene. For example, a first virtual character is displayed in a virtual scene, where the first virtual character is a virtual character controlled by a first terminal, and the virtual scene includes a second virtual character.

The first virtual character is a virtual character controlled by the first terminal, and the virtual scene further includes a second virtual character.

In this embodiment, the virtual scene may be a virtual scene that uses vehicle interaction in a game battle, or may be a virtual scene that is independently developed for vehicle interaction. The vehicle interaction means that a first interaction action is performed between a virtual character and a virtual vehicle in a virtual scene.

In the first case, the first terminal is configured to control the first virtual character, and a second terminal is configured to control the second virtual character. In the second case, the first terminal is configured to control the second virtual character, and the second terminal is configured to control the first virtual character. This is not limited herein. In the third case, the first terminal may be configured to separately control the first virtual character and the second virtual character. In this disclosure, the first case is used as an example for description.

In some embodiments, in a case that the computer device is the first terminal, the first virtual character controlled by the first terminal in the virtual scene is displayed in the first terminal, and the second virtual character controlled by the second terminal in the virtual scene is displayed in the first terminal. In this case, a trigger operation is received in the first terminal for controlling the first virtual character. Alternatively, in a case that the computer device is the second terminal, the first virtual character controlled by the first terminal in the virtual scene is displayed in the second terminal, and the second virtual character controlled by the second terminal in the virtual scene is displayed in the second terminal. In this case, the trigger operation is received in the second terminal for controlling the second virtual character. In this embodiment, in a case that the computer device is the first terminal is used as an example for description.

In some embodiments, there may be one or more second terminals. This is not limited herein.

In some embodiments, the first virtual character is a virtual character mainly controlled by the first terminal. Alternatively, the first virtual character is a virtual object sub-controlled by the first terminal, and the first terminal mainly controls a virtual character other than the first virtual character.

The first virtual character and the second virtual character are two different virtual characters in the virtual scene. The first virtual character and the second virtual character are of a teammate relationship; or the first virtual character and the second virtual character are of a non-teammate relationship.

In some embodiments, the first interaction action includes at least one of actions such as riding a virtual vehicle, driving a virtual vehicle, leaving a virtual vehicle, or using a vehicle to honk while driving a virtual vehicle.

For example, in a virtual scene in which vehicle interaction is used in the game battle, the user determines a virtual character corresponding to a logged-in account by creating a virtual character, and participates in the game battle by controlling an action of the virtual character. The user may also control the virtual character to interact with the virtual vehicle while sending the vehicle interaction prompt message to another player to prompt the another player to interact with the virtual vehicle.

For example, in a virtual scene of a simulated driving school independently developed for vehicle interaction, the user determines the virtual character corresponding to the logged-in account by creating the virtual character, and participates in training in the simulated driving school by controlling the action of the virtual character. The user may also control the virtual character to interact with the virtual vehicle while sending the vehicle interaction prompt message to another student to prompt the another student to interact with the virtual vehicle.

Operation 420: Display a vehicle interaction control in response to a vehicle interaction condition being met between the first virtual character and a virtual vehicle. For example, a vehicle interaction interface is displayed when a vehicle interaction condition is met between the first virtual character and a virtual vehicle.

The vehicle interaction control is configured to indicate the first virtual character to perform the first interaction action with the virtual vehicle.

For example, one or more virtual vehicles are currently displayed in the terminal picture of the first terminal.

For example, the vehicle interaction condition refers to a condition that enables the first virtual character to perform the first interaction action with the virtual vehicle.

For example, the vehicle interaction condition met between the first virtual character and the virtual vehicle may be a distance requirement between the first virtual character and the virtual vehicle, or may be a carrying state requirement of the first virtual character on the virtual vehicle, or may be a belonging state requirement of the first virtual character on the virtual vehicle.

When the vehicle interaction condition includes the distance requirement, and when a distance between the first virtual character and the virtual vehicle reaches a preset distance threshold, it represents that the vehicle interaction condition is met between the first virtual character and the virtual vehicle.

When the vehicle interaction condition includes the carrying state requirement, a main driving seat is arranged in the virtual vehicle. When the first virtual character rides on the main driving seat, it represents that the vehicle interaction condition between the first virtual character and the virtual vehicle is met. The main driving seat refers to a seat for driving the virtual vehicle.

When the vehicle interaction condition includes the belonging state requirement, and when the first virtual character uses a redemption resource to purchase the virtual vehicle in the virtual scene, it represents that the vehicle interaction condition is met between the first virtual character and the virtual vehicle.

In some embodiments, a situation in which the vehicle interaction control is displayed includes at least one of the following situations:

1. If there is only one virtual vehicle in a designated distance of the first virtual character, the vehicle interaction control of the virtual vehicle is displayed.

For example, when there is only one virtual vehicle in a designated distance of the first virtual character, the vehicle interaction control of the virtual vehicle is displayed.

2. If there are two or more virtual vehicles in a designated distance of the first virtual character, a vehicle interaction control of a virtual vehicle that meets a condition for displaying the vehicle interaction control is displayed.

In some embodiments, a situation in which the vehicle interaction control is displayed includes at least one of the following situations:

Case 1: Display the vehicle interaction control of each virtual vehicle in the designated distance of the first virtual character. In some embodiments, the display of the vehicle interaction control corresponds to an arrangement relationship of virtual vehicles in the distance of the first virtual character in the virtual scene.

In some embodiments, the virtual scene includes a plurality of candidate virtual vehicles that meet the vehicle interaction condition with the first virtual character. The vehicle interaction controls respectively corresponding to the plurality of candidate virtual vehicles are displayed in response to the vehicle interaction condition being met between the first virtual character and the plurality of candidate virtual vehicles, the display of the vehicle interaction controls corresponding to an arrangement relationship of the plurality of candidate virtual vehicles in the virtual scene.

For example, there are also the plurality of candidate virtual vehicles in the virtual scene that meet the vehicle interaction condition with the first virtual character. Therefore, based on the arrangement relationship of the plurality of candidate virtual vehicles in the virtual scene, the vehicle interaction controls respectively corresponding to the plurality of candidate virtual vehicles are sequentially displayed.

In some embodiments, the arrangement relationship includes at least one of the following relationships: a distance from the first virtual character, a distance from a current viewing range of the first virtual character, or a designated arrangement order (for example, from left to right) in the virtual scene.

For example, based on a distance between the virtual vehicle in the designated distance of the first virtual character and the first virtual character from near to far, the vehicle interaction controls corresponding to virtual vehicles are sequentially displayed from left to right in a designated region of the terminal picture.

In other words, when the virtual scene includes the plurality of candidate virtual vehicles, the vehicle interaction controls respectively corresponding to the plurality of candidate virtual vehicles are sequentially displayed based on the arrangement relationship, which enables the user to directly select a vehicle interaction control on which vehicle interaction needs to be performed based on the arrangement relationship, thereby improving efficiency of human-computer interaction.

Case 2: Display a vehicle interaction control of a virtual vehicle closest to the first virtual character.

For example, there are three virtual vehicles in the virtual scene within a designated distance range of the first virtual character: a first virtual vehicle, a second virtual vehicle, and a third virtual vehicle. A distance between the first virtual vehicle and the first virtual character is closest, and vehicle interaction controls of the first virtual vehicle, including a driving control and a riding control, are displayed at a designated position in the current terminal picture. The driving control is configured to trigger riding in the main driving seat and driving of the virtual vehicle, and the riding control is configured to trigger riding in any empty seat other than the main driving seat.

Case 3: Display a vehicle interaction control of a virtual vehicle in a direction of an orientation of the first virtual character.

For example, there are two virtual vehicles in the virtual scene within the designated distance of the first virtual character: the first virtual vehicle and the second virtual vehicle. Connecting lines from the first virtual vehicle and the second virtual vehicle to the first virtual character are respectively a first connecting line and a second connecting line. When an angle between the first connecting line and an orientation of the first virtual character is smaller than an angle between the second connecting line and an orientation of the first virtual character, the vehicle interaction controls of the first virtual vehicle, including the driving control and the riding control, are displayed at the designated position in the current terminal picture.

3. When the first virtual character drives the virtual vehicle, the vehicle interaction control of the virtual vehicle is displayed.

For example, when the first virtual character drives the virtual vehicle, a honking control (or horn control) of the virtual vehicle is displayed.

4. After the first virtual character successfully purchases the virtual vehicle, the vehicle interaction control of the virtual vehicle is displayed.

The foregoing situation of displaying the vehicle interaction control is only illustrative example. This is not limited in the embodiments of this disclosure. A trigger operation on a vehicle interaction control corresponding to a designated virtual vehicle in the plurality of candidate virtual vehicles is received.

Operation 430: Receive a trigger operation on the vehicle interaction control. In some embodiments, a manner of the trigger operation on the vehicle interaction control includes at least one of the following manners:

1. Perform a slide operation on the vehicle interaction control, that is, slide the vehicle interaction control for a preset distance threshold.

For example, the slide operation is received. A start position of the slide operation is on the vehicle interaction control. Hold and slide up the vehicle interaction control. When a distance of the slide operation is greater than or equal to 60 pixels (px), the trigger operation on the vehicle interaction control is completed.

2. Perform a drag operation on the vehicle interaction control, that is, drag the vehicle interaction control to a designated region range.

In some embodiments, the designated region range may be a preset region range including a message interaction control (message interaction interface), or the designated region range may be a preset region range at a designated distance from an upper, a lower, a left, and a right sides of the vehicle interaction control.

For example, a terminal interface also displays the message interaction control. The drag operation of dragging the vehicle interaction control to the preset region range including the message interaction control is received, and the trigger operation on the vehicle interaction control is completed.

That is, the drag operation that drags the vehicle interaction control to the designated region range is used as the trigger operation, which can avoid accidentally touching the vehicle interaction control for triggering, improves accuracy of the trigger operation, and reduces a rate of accidental touches.

3. Perform a gravitational pressing operation on the vehicle interaction control.

For example, the pressing operation is received. When a pressure exerted by the pressing operation exceeds or reaches a preset pressure threshold, the gravitational pressing operation on the vehicle interaction control is completed.

4. Perform a long press operation on the vehicle interaction control.

For example, the press operation is received. The vehicle interaction control is held for more than 3 seconds to complete the trigger operation on the vehicle interaction control.

The foregoing manner of the trigger operation on the vehicle interaction control is only illustrative example. This is not limited in the embodiments of this disclosure.

In some embodiments, when there are a plurality of candidate virtual vehicles in the virtual scene that meet the vehicle interaction condition with the first virtual character, a trigger operation on the vehicle interaction control corresponding to a designated virtual vehicle in the plurality of candidate virtual vehicles is received.

In this embodiment, if there are the plurality of candidate virtual vehicles, a trigger operation on the vehicle interaction control corresponding to one of the candidate virtual vehicles is received.

Operation 440: In response to the trigger operation, send a vehicle interaction prompt message to the second virtual character, and display an animation of performing a first interaction action between the first virtual character and the virtual vehicle. For example, a vehicle interaction message is transmitted to the second virtual character and an animation of a first interaction between the first virtual character and the virtual vehicle is displayed by the first terminal in response to a vehicle trigger operation received by the first terminal on the vehicle interaction interface.

The vehicle interaction prompt message is configured for prompting that a second interaction action is performed between the second virtual character and the virtual vehicle.

In the first case, for example, the first terminal controls the first virtual character and the second terminal controls the second virtual character. After receiving the trigger operation, the first terminal sends the vehicle interaction prompt message to the second terminal controlling the second virtual character based on the trigger operation, and displays an animation of performing the first interaction action between the first virtual character and the virtual vehicle in the first terminal.

In another case, for example, the first terminal simultaneously controls the first virtual character and the second virtual character. A first controller and a second controller are connected to the first terminal. The first controller controls the first virtual character, and the second controller controls the second virtual character. After receiving the trigger operation, the first controller sends the vehicle interaction prompt message to the second controller through the first terminal, and displays an animation of a designated interaction action between the first virtual character and the virtual vehicle in the first terminal.

For example, the vehicle interaction prompt message is configured for prompting that a current second virtual character is qualified to perform the first interaction action with the virtual vehicle.

In some embodiments, the second interaction action includes at least one of actions such as riding a virtual vehicle, driving a virtual vehicle, leaving a virtual vehicle, or using a vehicle to honk while driving a virtual vehicle.

In some embodiments, the first interaction action and the second interaction action are the same interaction action, for example: both the first virtual character and the second virtual character sit on empty seats of the virtual vehicle. Alternatively, the first interaction action and the second interaction action are different interaction actions, for example: the first virtual character drives the virtual vehicle, and the second virtual character sits in an assistant driver seat.

In some embodiments, a manner of sending a vehicle interaction prompt message to the second virtual character, and displaying an animation of performing a first interaction action between the first virtual character and the virtual vehicle in response to the trigger operation includes at least one of the following manners:

1. An animation of the first virtual character switching from a first state of being outside the virtual vehicle to a second state of being inside the virtual vehicle is displayed in response to a vehicle state switching operation.

For example, the first state refers to a state in which the first virtual character is outside the virtual vehicle, and the first state includes at least one of states such as standing, squatting, or lying. The second state refers to a state in which the first virtual character is inside the vehicle, and the second state includes at least one of states such as driving a virtual vehicle or riding a virtual vehicle.

For example, the first virtual character switches from the first state of being outside the virtual vehicle to a driving state of the virtual vehicle, and sends the vehicle interaction prompt message to the second virtual character in response to a driving operation; or first virtual character switches from the first state of being outside the virtual vehicle to a state of riding in the virtual vehicle, and sends the vehicle interaction prompt message to the second virtual character in response to a riding operation.

That is, through the driving operation, the first virtual character switches from the first state to the second state of being inside the virtual vehicle and simultaneously sends the vehicle interaction prompt message to the second virtual character. This not only conveys the intention, but also improves efficiency of message generation.

That is, regardless of whether the first state is converted to the driving state or the riding state, the vehicle interaction prompt message can be sent to the second virtual character while the state is changed, so that both a driving object and a riding object can send the vehicle interaction prompt message, expanding an audience group for one-tap message transmission.

2. In response to a honking operation, the vehicle interaction prompt message is sent to the second virtual character, a honking trigger action performed on the first virtual character for the virtual vehicle is displayed, and a honking effect of the virtual vehicle is expressed.

For example, the honking operation refers to the first virtual character performing honking by using a horn in the virtual vehicle and performing a honking effect in the virtual scene, and when the second virtual character is in an effect effective range of the honking effect, the second virtual character can hear the honking effect. The effect effective range refers to a sound propagation range of the honking effect.

For example, the vehicle interaction prompt message is sent to the second virtual character based on the honking operation, and a process in which the first virtual character uses the horn in the virtual vehicle to honk is displayed.

In other words, when the vehicle interaction control is implemented as a honking control, the vehicle interaction prompt message can also be sent to the second virtual character while the first virtual character uses the horn in the virtual vehicle to honk, ensuring comprehension of prompts and enriching a variety of interaction prompt manners.

In some embodiments, the virtual scene includes the first virtual vehicle and the second virtual vehicle, and the vehicle interaction condition is met between the first virtual vehicle and the second virtual vehicle and the first virtual character. The trigger operation on the vehicle interaction control corresponding to the first virtual vehicle is received. In a process of displaying the animation of performing the first interaction action between the first virtual character and the first virtual vehicle, in response to receiving a trigger operation on a vehicle interaction control corresponding to the second virtual vehicle, a state switching from a state of being inside the first virtual vehicle to a state of being inside the second virtual vehicle is displayed, and the vehicle interaction prompt message corresponding to the second virtual vehicle is sent to the second virtual character.

In still another case, the virtual scene includes the first virtual vehicle and the second virtual vehicle that meet the vehicle interaction condition with the first virtual character, and vehicle interaction controls respectively corresponding to the first virtual vehicle and the second virtual vehicle are displayed. If a trigger operation on the vehicle interaction control corresponding to the first virtual vehicle is received, in a process of displaying the animation of performing the first interaction action between the first virtual character and the first virtual vehicle, the vehicle interaction control corresponding to the second virtual vehicle can also be displayed. If a trigger operation on the vehicle interaction control corresponding to the second virtual vehicle is received, an animation that the first virtual character switching from being in a second state of the first virtual vehicle to being in a third state of the second virtual vehicle can be displayed, and the virtual vehicle interaction prompt message is transmitted to the second virtual character again.

That is, in a process in which the virtual scene includes the plurality of virtual vehicles, a process of switching states between the virtual character and different virtual vehicles can be implemented through the vehicle interaction control, which improves efficiency of human-computer interaction, avoids continuous actions of the virtual character riding in/leaving the virtual vehicle, and reduces overheads of rendering a picture of the virtual scene by a computer.

According to the method provided in this embodiment, a method in which the virtual character performs different interaction activities with different virtual vehicles while transmitting the vehicle interaction prompt message to another virtual character is provided, vehicle interaction controls corresponding to different interaction manners are accurately provided, a convenient operation for transmitting the vehicle interaction prompt message is uniformly provided, and an implementation speed of related operations is improved.

According to the method provided in this embodiment, a method for transmitting a corresponding vehicle interaction prompt message to another virtual character while the virtual character and the virtual vehicle perform different interaction activities is provided, which conveys a message intention and improves a transfer effect of the vehicle interaction prompt message.

In some embodiments, a virtual character list is displayed, the virtual character list including character options respectively corresponding to the plurality of candidate virtual characters; a selection operation (character selection operation) on a character option corresponding to a third virtual character in the plurality of candidate virtual characters is received; and the vehicle interaction prompt message is sent to the third virtual character, and an animation of performing the first interaction action between the first virtual character and the virtual vehicle is displayed in response to the selection operation.

For example, after the trigger operation on the vehicle interaction control is received, the virtual character list is displayed in the virtual scene picture, the virtual character list including character options respectively corresponding to a plurality of candidate virtual characters that can perform a second interaction action with the virtual vehicle. After a selection operation on a character option of the third virtual character in the plurality of candidate virtual characters is received, the vehicle interaction prompt message is separately sent to the third virtual character based on the selection operation, and the animation of performing the first interaction action between the first virtual character and the virtual vehicle is displayed.

That is, after the trigger operation on the vehicle interaction control is received, the virtual character list is displayed, so that a virtual object that intends to separately transmit the vehicle interaction prompt information can be selected from. Therefore, the vehicle interaction prompt information is separately sent to the third virtual character while the first interaction action is performed between the first virtual character and the virtual vehicle, which expands diversity of information transmitting and implements a separate interaction function with the virtual object.

According to the method provided in this embodiment, a plurality of operation manners for triggering the vehicle interaction control are provided, which enriches diversity of operations, and gives the user more choices of operation manners.

According to the method provided in this embodiment, a vehicle interaction control display method in which a plurality of virtual vehicles simultaneously exist in the virtual scene is provided, and a picture display rule is specified to make interface display clearer and improve user experience.

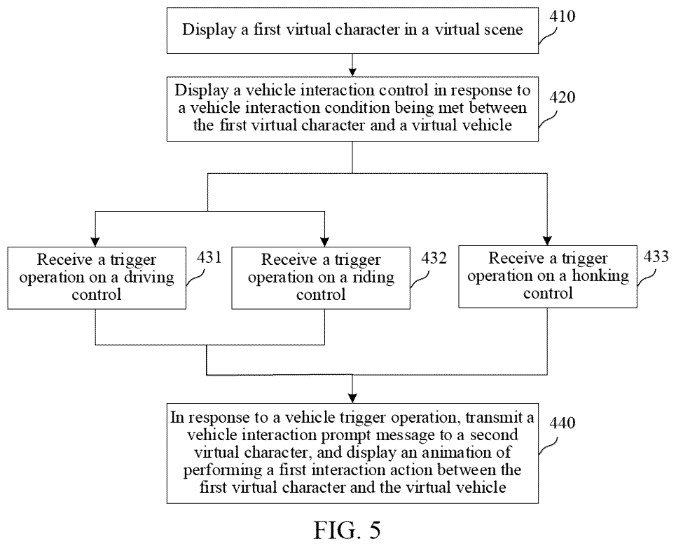

FIG. 5 is a flowchart of a vehicle interaction method of different vehicle interaction controls in a virtual scene according to an embodiment of this disclosure. As shown in FIG. 5, the foregoing operation 430 includes two cases. In the following first case, operation 430 includes operation 431 or operation 432, and in the following second case, operation 430 is implemented as operation 433.

Case 1: The vehicle interaction condition met between the first virtual character and the virtual vehicle includes a distance requirement between the first virtual character and the virtual vehicle, and the vehicle interaction control includes a state switching control (or state switching interface), the state switching control being a control for switching a carrying state of the virtual vehicle (or vehicle carrying state).

In some embodiments, the carrying state includes a driving state and a riding state. Therefore, the state switching control is configured to switch between the driving control and the riding control.

Operation 431: Receive a trigger operation on a driving control.

For example, the driving control is dragged from a current display position of the driving control to the message interaction control and released to complete an operation of triggering the vehicle interaction prompt message for the driving control.

Operation 432: Receive a trigger operation on a riding control.

For example, the riding control is slid up, and when a slide distance is greater than or equal to 60 pixels, the riding control is released to complete an operation of triggering the vehicle interaction prompt message for the riding control.

Case 2: The vehicle interaction condition met between the first virtual character and the virtual vehicle includes a carrying requirement (vehicle carrying requirement) of the first virtual character for the virtual vehicle, and the vehicle interaction control includes an action interaction control,

the action interaction control being a control that performs an action interaction presentation on the carried virtual vehicle.

For example, the action interaction control may be implemented as a honking control, a windowing control, a turn signal control, and the like. A user of the honking control triggers a honking effect of the virtual vehicle, the windowing control is configured to control an open/close state of a window of the virtual vehicle, and the turn signal control is configured to control a turn signal of the virtual vehicle to be turned on or off. In the embodiments of this disclosure, an example in which the action interaction control is implemented as the honking control is used for description.

Operation 433: Receive a trigger operation on a honking control.

For example, the honking control is long pressed. When the honking control is pressed for more than 3 seconds, an operation of triggering the vehicle interaction prompt message on the honking control is completed.

In summary, the method provided in the embodiments of this disclosure clarifies a process of the vehicle interaction method of different vehicle interaction controls, provides a convenient operation for different vehicle interaction processes to trigger the transmitting of the vehicle interaction prompt message, and improves an implementation speed of a transmitting operation on the vehicle interaction prompt message.

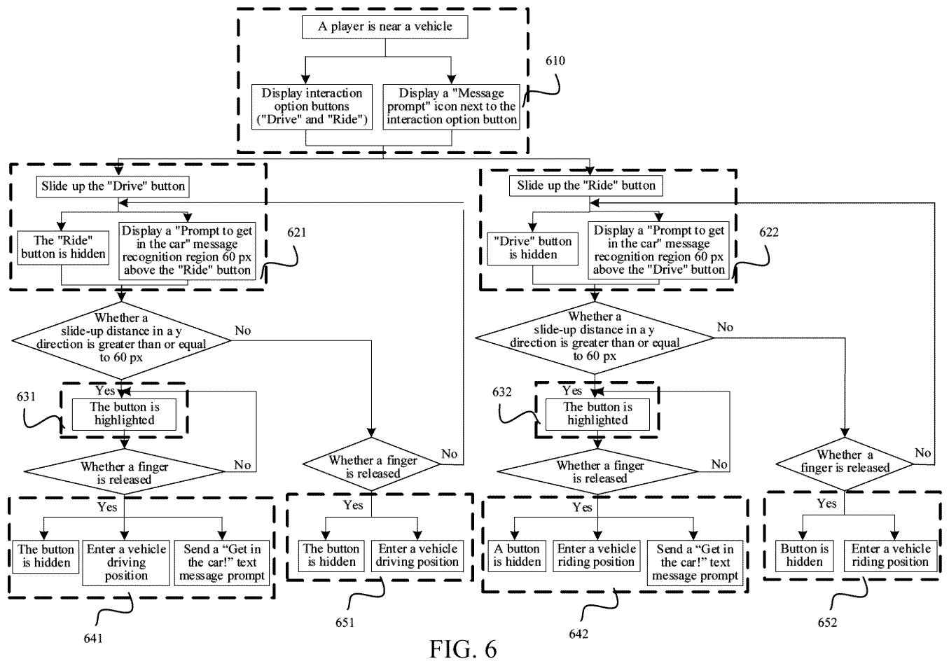

FIG. 6 is a flowchart of simultaneously triggering system determining of activation and taking effect of a message prompt through vehicle interaction according to an embodiment of this disclosure. As shown in FIG. 6, FIG. 6 includes two cases of operating the virtual character to perform driving interaction with the virtual vehicle and operating the virtual character to perform riding interaction with the virtual vehicle. In the foregoing two cases, operations of the method respectively include:

Case 1: In a case that the player operates the virtual character to perform driving interaction with the virtual vehicle. The method includes the following operations:

Operation 610: When a virtual character is near a vehicle, a vehicle interaction control is displayed, and a “Message prompt” icon is displayed next to the vehicle interaction control.

The virtual character is near the vehicle, that is, the virtual vehicle is within a designated distance range of the virtual character.

For example, the vehicle interaction control includes a drive button and a ride button.

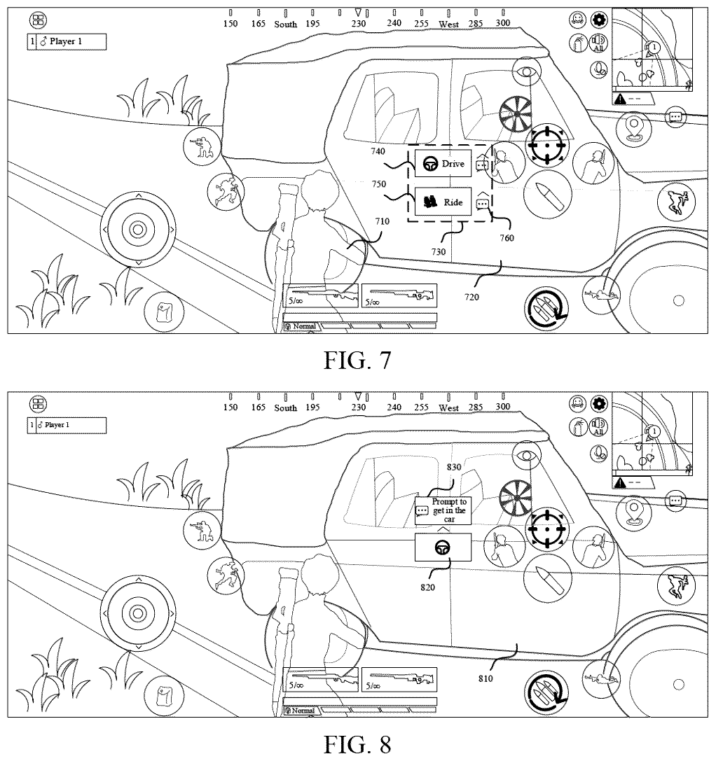

For example, FIG. 7 is a schematic diagram of a vehicle interaction control that implements carrying according to an embodiment of this disclosure. As shown in FIG. 7, a distance between a virtual character 710 and a virtual vehicle 720 is within a designated distance range, and a vehicle interaction control 730 is displayed, including a drive button 740 and a ride button 750. A message prompt icon 760 is displayed next to both the drive button 740 and the ride button 750.

Operation 621: When a player slides up a “Drive” button, a “Ride” button is hidden, and a “prompt to get in a car” message recognition region is displayed 60 px directly above the “Drive” button.

For example, FIG. 8 is a schematic diagram of triggering the display of a message interaction control through a driving operation according to an embodiment of this disclosure. As shown in FIG. 8, when the player selects the vehicle interaction control of a virtual vehicle 810, that is, a drive button 820, a ride button is hidden, and the message interaction control is displayed 60 px above the drive button 820, that is, a “Message prompt” message recognition region 830 is displayed.

In this embodiment, simultaneously triggering system determining of activation and taking effect of the message prompt through vehicle interaction is implemented by determining whether the slide-up distance operation and the slide up operation are completed.

In the first step, when the player performs a slide-up “Drive” button operation, a program that provides the virtual scene on the current terminal automatically determines whether to trigger the message interaction control, that is, it is determined whether the player slides up the “Drive” button by a distance greater than or equal to 60 px. If yes, enter a next operation of a current branch. Otherwise, enter a next operation of determining.

In the second step, it is determined whether the player releases a finger. If yes, enter the next operation of the current branch. Otherwise, return to a previous operation.

Operation 631: When the player slides up the “Drive” button by a distance greater than or equal to 60 px, the button is highlighted.

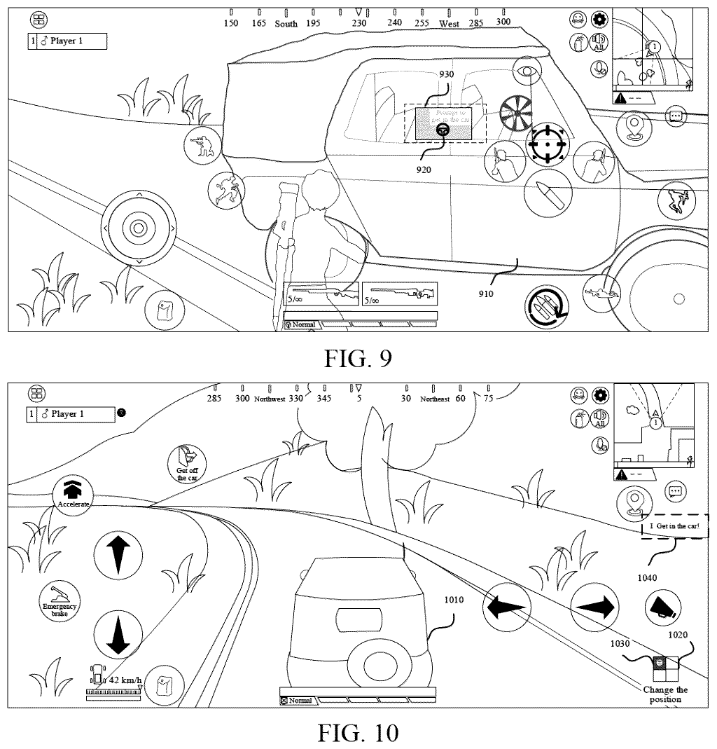

For example, FIG. 9 is a schematic diagram of activating a message interaction control through a driving operation according to an embodiment of this disclosure. As shown in FIG. 9, when the player slides up a drive button 920 of a virtual vehicle 910 to an illustrated message interaction control recognition region 930, the drive button 920 is highlighted.

Operation 641: When the “Drive” button is highlighted, the player releases the finger, the button is hidden, and a virtual character enters a vehicle driving position and transmits out a vehicle interaction prompt message.

In some embodiments, the vehicle interaction prompt message may be a text message prompt such as “Get in the car!” or an animated expression prompt. This is not limited in this disclosure.

For example, FIG. 10 is a schematic diagram of triggering a message interaction control to take effect through a driving operation according to an embodiment of this disclosure. As shown in FIG. 10, a virtual character enters a driving position of a virtual vehicle 1010, a vehicle seat icon 1020 displays that the driving position 1030 is highlighted, the drive button is hidden, and a text message prompt 1040 of “Get in the car!” is displayed.

Operation 651: When the player slides up the “Drive” button by a distance less than 60 px and the player releases the finger, the button is hidden, and the virtual character enters the vehicle driving position.

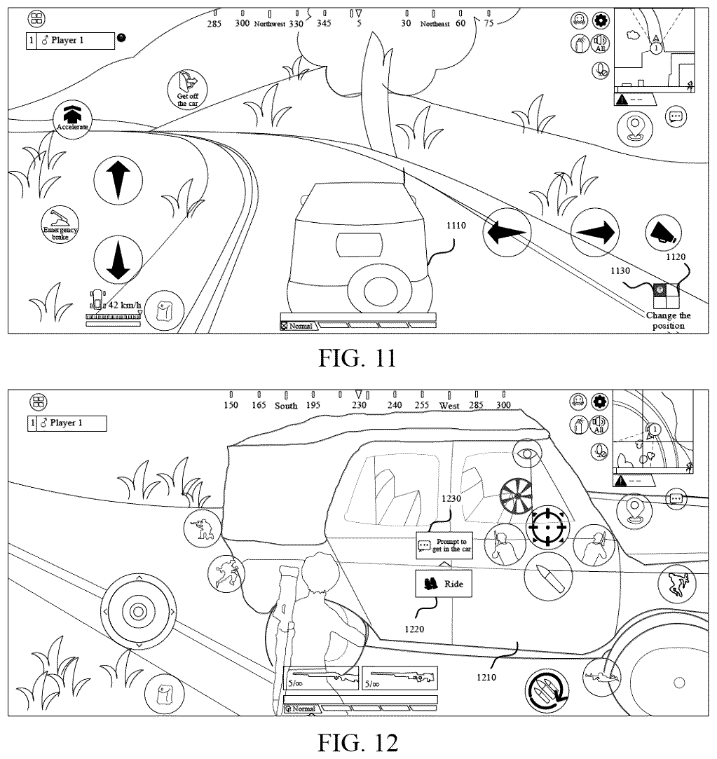

For example, FIG. 11 is a schematic diagram of driving interaction according to an embodiment of this disclosure. As shown in FIG. 11, the virtual character enters a driving position of a virtual vehicle 1110, a vehicle seat icon 1120 displays that a driving position 1130 is highlighted, and the drive button is hidden.

Case 2: In a case that the player operates the virtual character to perform riding interaction with the virtual vehicle. The method includes the following operations:

Operation 610: When the virtual character is near a vehicle, a vehicle interaction control is displayed.

In some embodiments, a “Message prompt” icon is displayed next to the vehicle interaction control. The virtual character is near the vehicle, that is, the virtual vehicle is within a designated distance range of the virtual character. For example, the vehicle interaction control includes a drive button and a ride button.

For example, FIG. 7 is a schematic diagram of a vehicle interaction control that implements carrying according to an embodiment of this disclosure. As shown in FIG. 7, a distance between a virtual character 710 and a virtual vehicle 720 is within a designated distance range, and a vehicle interaction control 730 is displayed, including a drive button 740 and a ride button 750. A message prompt icon 760 is displayed next to both the drive button 740 and the ride button 750.

Operation 622: When a player slides up a “Ride” button, a “Drive” button is hidden, and a “prompt to get in a car” message recognition region is displayed 60 px directly above the “Ride” button.

For example, FIG. 12 is a schematic diagram of triggering the display of a message interaction control through a riding operation according to an embodiment of this disclosure. As shown in FIG. 12, when the player selects the vehicle interaction control of a virtual vehicle 1210, that is, a ride button 1220, a drive button is hidden, and the message interaction control is displayed 60 px above the ride button 1220, that is, a “Message prompt” message recognition region 1230 is displayed.

In this embodiment, simultaneously triggering system determining of activation and taking effect of the message prompt through vehicle interaction is implemented by determining whether the slide-up distance operation and the slide up operation are completed.

In the first step, when the player performs a slide-up “Ride” button operation, a program that provides the virtual scene on the current terminal automatically determines whether to trigger the message interaction control, that is, it is determined whether the player slides up the “Ride” button by a distance greater than or equal to 60 px. If yes, enter a next operation of a current branch. Otherwise, enter a next operation of determining. In the second step, it is determined whether the player releases a finger. If yes, enter the next operation of the current branch. Otherwise, return to a previous operation.

Operation 632: When the player slides up the “Ride” button by a distance greater than or equal to 60 px, the button is highlighted.

For example, FIG. 13 is a schematic diagram of activating a message interaction control through a riding operation according to an embodiment of this disclosure. As shown in FIG. 13, when the player slides up a ride button 1320 of a virtual vehicle 1310 to an illustrated message interaction control recognition region 1330, the ride button 1320 is highlighted.

Operation 642: When the “Ride” button is highlighted, the player releases the finger, the button is hidden, and a virtual character enters a vehicle riding position and transmits out a vehicle interaction prompt message.

In some embodiments, the vehicle interaction prompt message may be a text message prompt such as “Get in the car!” or an animated expression prompt. This is not limited in this disclosure.

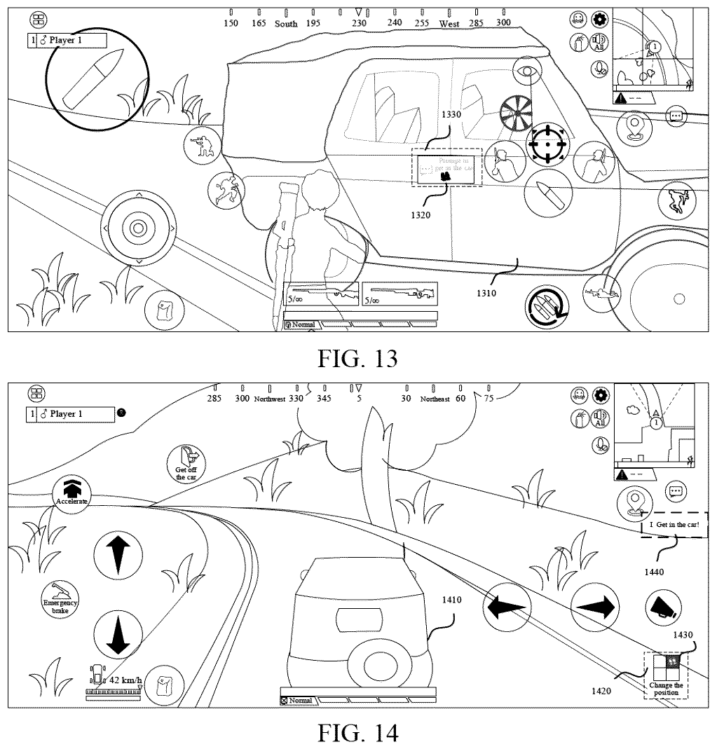

For example, FIG. 14 is a schematic diagram of triggering a message interaction control to take effect through a riding operation according to an embodiment of this disclosure. As shown in FIG. 14, a virtual character enters a riding position of a virtual vehicle 1410, a vehicle seat icon 1420 displays that the riding position 1430 is highlighted, the ride button is hidden, and a text message prompt 1440 of “Get in the car!” is displayed.

Operation 652: When the player slides up the “Ride” button by a distance less than 60 px and the player releases the finger, the button is hidden, and the virtual character enters the vehicle riding position.

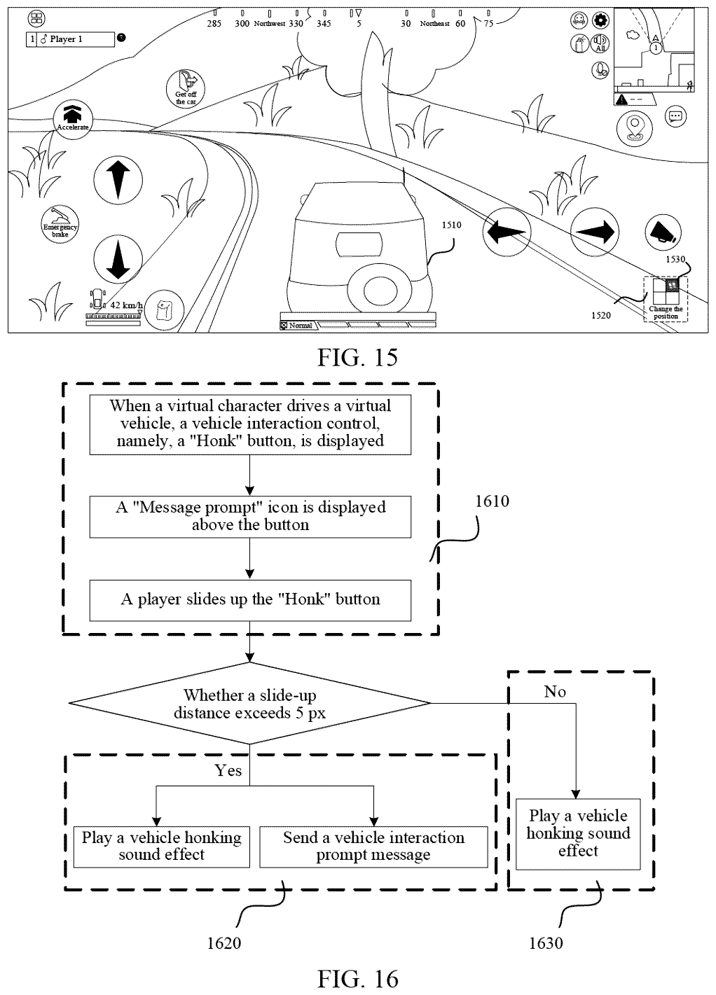

For example, FIG. 15 is a schematic diagram of riding interaction according to an embodiment of this disclosure. As shown in FIG. 15, the virtual character enters a riding position of a virtual vehicle 1510, a vehicle seat icon 1520 displays that a riding position 1530 is highlighted, and the ride button is hidden.

In summary, the method provided in this embodiment clarifies a determining procedure of simultaneously triggering activation and taking effect of the message prompt through vehicle interaction, provides the player with a convenient operation to quickly transmit the vehicle interaction prompt message while interacting with the virtual vehicle, and optimizes the user experience.

FIG. 16 is a flowchart of simultaneously triggering system determining of activation and taking effect of a message prompt through honking interaction according to an embodiment of this disclosure. As shown in FIG. 16, the method includes the following operations:

Operation 1610: When a virtual character drives a virtual vehicle, a vehicle interaction control, that is, a “Honk” button, is displayed. A “Message prompt” icon is displayed above the button, and a player slides up the “Honk” button.

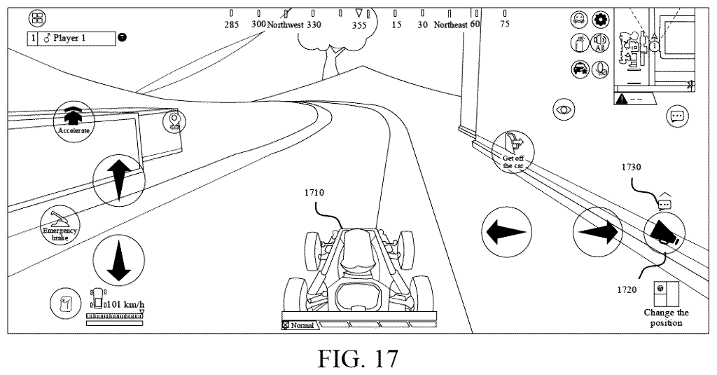

For example, FIG. 17 is a schematic diagram of a vehicle interaction control that implements carrying according to an embodiment of this disclosure. As shown in FIG. 17, a virtual character drives a virtual vehicle 1710, and a vehicle interaction control, that is, a honking button 1720, is displayed. A message prompt icon 1730 is displayed above the honking button 1720.

In this embodiment, simultaneously triggering system determining of activation and taking effect of the message prompt through honking interaction is implemented by determining a slide-up operation distance.

When the player performs a slide-up “Honk” button operation, a program that provides the virtual scene on the current terminal automatically determines whether to trigger the vehicle interaction prompt message, that is, it is determined whether the player slides up the “Honk” button by a distance greater than or equal to 5 px. If yes, enter operation 1620. Otherwise, enter operation 1630.

Operation 1620: When the player slides up a “Honk” button by a distance greater than or equal to 5 px, a vehicle honking sound effect is played and a vehicle interaction prompt message is sent.

In some embodiments, the vehicle interaction prompt message may be a text message prompt such as “Get in the car!” or an animated expression prompt. This is not limited in this disclosure.

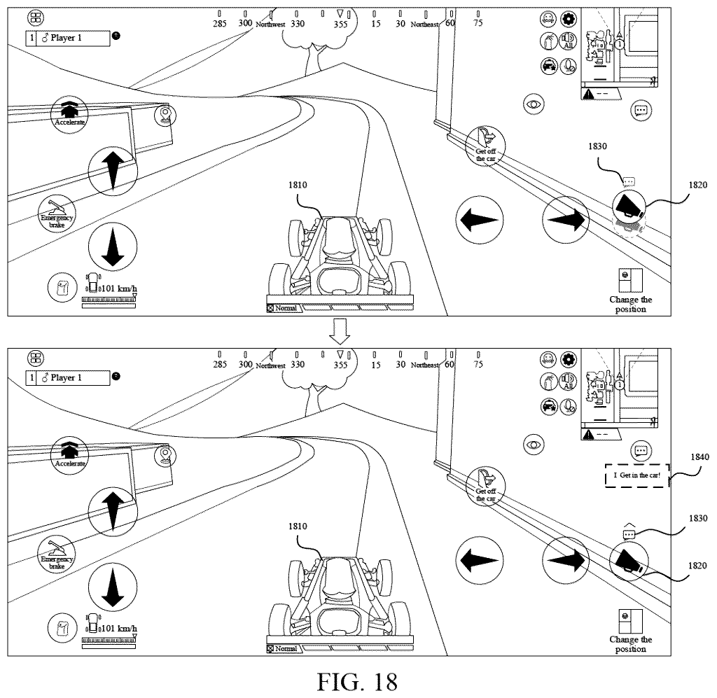

For example, FIG. 18 is a schematic diagram of triggering a message interaction control to take effect through honking according to an embodiment of this disclosure. As shown in FIG. 18, when a honking button 1820 of a virtual vehicle 1810 is slid up by a distance more than 5 px, a message interaction control 1830 is triggered, a message interaction control 1830 is highlighted, and a text message prompt 1840 of “Get in the car!” is displayed.

Operation 1630: When the player slides up the “Honk” button by a distance less than 5 px, the vehicle honking sound effect is played.

In some embodiments, the honking sound effect may be a continuous audio based on duration of an operation on a honking button by the player, or a discontinuous audio based on a number of operations of a honking button by the player.

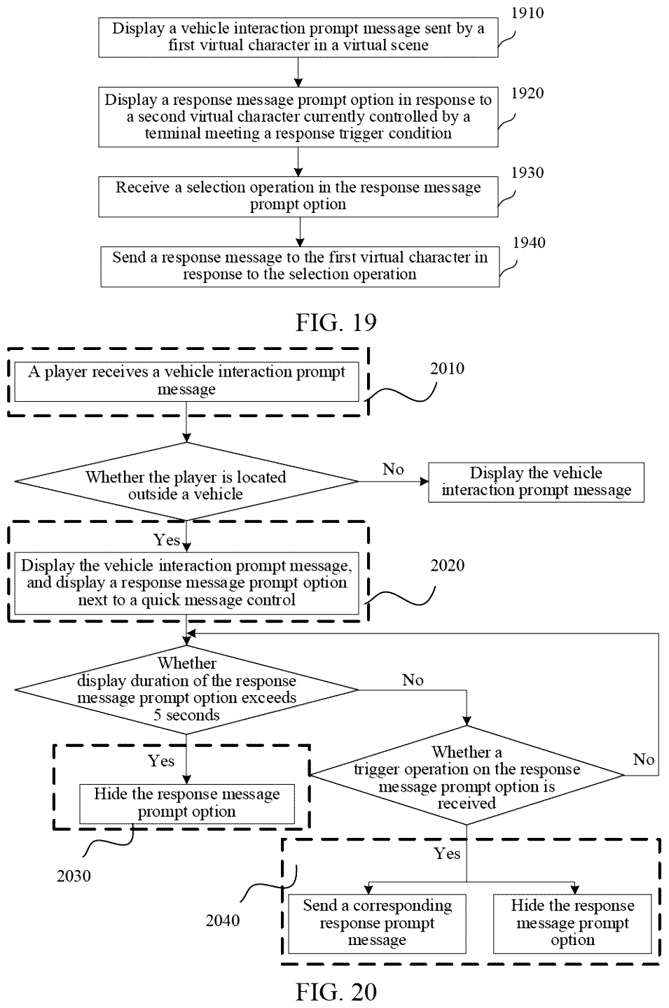

FIG. 19 is a flowchart of a vehicle interaction method in a virtual scene according to an embodiment of this disclosure. The method may be applied to a terminal or a server, or implemented by a server and a terminal in cooperation. In this embodiment, for example, the method is performed by a second terminal. As shown in FIG. 19, the method includes the following operations:

Operation 1910: Display a vehicle interaction prompt message sent by a first virtual character in a virtual scene.

The vehicle interaction prompt message is a message simultaneously sent when a first interaction action is performed between the first virtual character and the virtual vehicle through a vehicle interaction control.

For example, in a process of running an application on a current second terminal, the vehicle interaction prompt information sent by the first virtual character in the virtual scene is displayed.

For example, the first virtual character is controlled by the first terminal.

In some embodiments, the vehicle interaction prompt message may be represented as a text message or an animated expression message. This is not limited in this disclosure.

Operation 1920: Display a response message prompt option in response to a second virtual character controlled by a second terminal meeting a response trigger condition.

The response message prompt option is configured for implementing selection and quick transmitting of the response message, which is implemented as a bubble box that includes the response message.

For example, the response trigger condition refers to a condition in which the virtual character has a response to the response message prompt option.

In some embodiments, the response trigger condition includes a position condition or a distance condition.

For example, the response trigger condition is implemented such that the second virtual character currently controlled by the first terminal is outside the virtual vehicle when receiving the vehicle interaction prompt message sent by the first virtual character, or the second virtual character currently controlled by the first terminal is inside a designated distance range of the virtual vehicle when receiving the vehicle interaction prompt message sent by the first virtual character.

For example, the response message prompt option is displayed in response to the second virtual character currently controlled by the first terminal being outside the virtual vehicle when receiving the vehicle interaction prompt message sent by the first virtual character.

That is, the response message prompt option is displayed only when the second virtual character is outside the virtual vehicle when receiving the vehicle interaction prompt message sent by the first virtual character, which avoids that the response message prompt option is also displayed when the second virtual character is inside the virtual vehicle. In this way, pertinence of the message prompt is improved, the second virtual character inside the virtual vehicle is avoided to accidentally touch the response message prompt option, and efficiency of the message prompt is improved.

Operation 1930: Receive a selection operation in the response message prompt option.

In some embodiments, the selection operation may be a tap operation, a slide operation, a gravitational pressing operation, and the like on an option. This is not limited in this disclosure.

Operation 1940: Transmit a response message to a first virtual character in response to the selection operation.

The response message is configured for responding to the vehicle interaction prompt message.

In some embodiments, the response message is a system preset message, or the response message is a message customized by the player in advance.

For example, the response message is a text message corresponding to the system preset response message prompt option selected by the player.

In summary, according to the method provided in this embodiment, another vehicle interaction method in a virtual scene is provided, which provides a quick response operation manner for the player receiving the vehicle interaction prompt message, and complements a gap of being unable to respond quickly in this scene, and improves efficiency of interaction of the vehicle interaction prompt message.

FIG. 20 is a flowchart of system determining of activation and taking effect of a response message prompt option according to an embodiment of this disclosure. The method may be applied to a terminal or a server, or implemented by a server and a terminal in cooperation. In this embodiment, for example, the method is performed by a terminal. As shown in FIG. 20, the method includes the following operations:

Operation 2010: A player receives a vehicle interaction prompt message.

For example, the vehicle interaction prompt message may be a text prompt message such as “Get in the car!”.

In this embodiment, prompt to get in a car is used as an example. The activation of the response message prompt option is implemented by determining a position relationship between the virtual vehicle and the virtual character.

When the player receives the vehicle interaction prompt message, a program that provides the virtual scene on the current terminal automatically determines whether the second virtual character is outside the virtual vehicle with which the first virtual character interacts. If yes, enter operation 2020. Otherwise, only a text message prompt “Get in the car!” is displayed. The second virtual character is a virtual character of a login account of a current terminal in the virtual scene, and the first virtual character is a virtual character that interacts with the virtual vehicle and transmits the vehicle interaction prompt message to the second virtual character.

Operation 2020: The vehicle interaction prompt message is displayed while a response message prompt option is displayed next to a quick message control.

The quick message control is configured for selecting a quick message that is system preset or set by the player in advance for transmission.

In this embodiment, determining the taking effect of the response message prompt option is implemented by two-option determining of display duration of the response message prompt option and whether the response message prompt option has received a trigger operation.

In the first step, the program that provides the virtual scene on the current terminal automatically determines whether display duration of the response message prompt option exceeds 5 seconds. If yes, enter operation 2030. Otherwise, enter to a next operation of determining.

In the second step, the program that provides the virtual scene on the current terminal automatically determines whether the response message prompt option has received the trigger operation. If yes, enter operation 2040. Otherwise, return to a previous operation of determining.

Operation 2030: Hide the response message prompt option.

For example, the response message prompt option includes text message prompt buttons such as “I'm on my way!” and “Unavailable for now˜”.

In some embodiments, the display of the response message prompt option is hidden in response to display duration of the response message prompt option reaching a preset duration threshold.

In this embodiment, a duration threshold is preset. When the display duration of the response message prompt option in the virtual scene picture reaches the duration threshold, the display of the response message prompt option is hidden.

That is, the response message prompt option is displayed in a designated time range, which avoids interfering the display of another displayed content in the virtual scene picture, and improves pertinence of the message display.

Operation 2040: Based on a trigger operation on the response message prompt option, a corresponding response message prompt is sent and the response message prompt option is hidden.

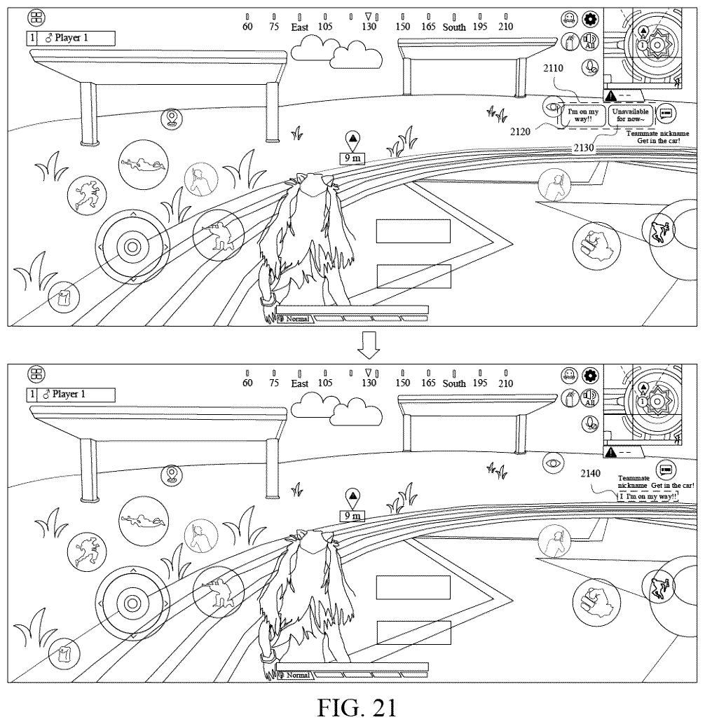

For example, FIG. 21 is a schematic diagram of response message interaction according to an embodiment of this disclosure. As shown in FIG. 21, a response message prompt option 2110 is displayed next to the quick message control, including an “I'm on my way!” button 2120 and an “Unavailable for now˜” button 2130. After a trigger operation on the “I'm on my way!” button by the player is received, a corresponding response message prompt “I'm on my way!” 2140 is sent, and the response message prompt option 2110 is hidden.

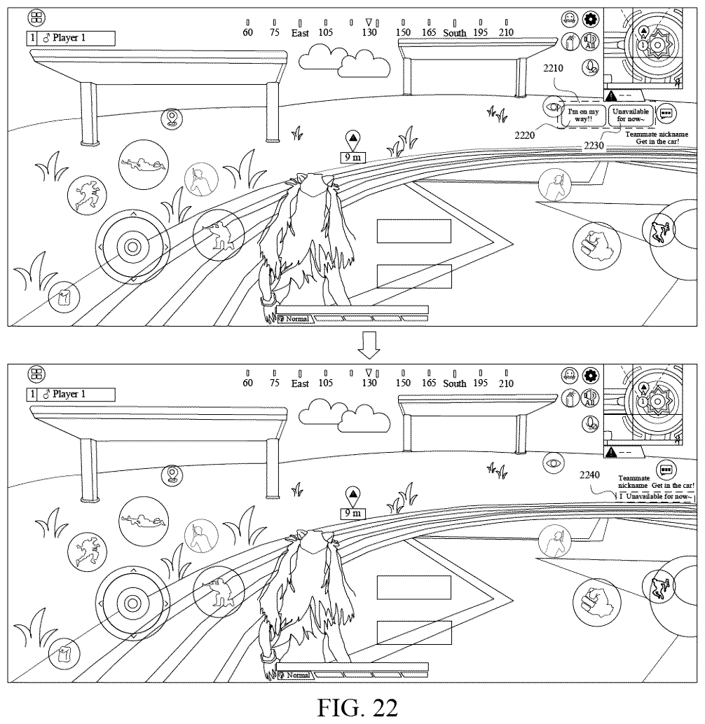

For example, FIG. 22 is a schematic diagram of response message interaction according to an embodiment of this disclosure. As shown in FIG. 22, a response message prompt option 2210 is displayed next to the quick message control, including an “I'm on my way!” button 2220 and an “Unavailable for now˜” button 2230. After a trigger operation on the “Unavailable for now˜” button by the player is received, a corresponding response message prompt “Unavailable for now˜” 2240 is sent, and the response message prompt option 2210 is hidden.

In some embodiments, the vehicle interaction control is displayed at a designated position of the response message prompt option in response to the second virtual character currently controlled by the first terminal meeting the response trigger condition; a trigger operation is received on the vehicle interaction control; and the second virtual character switching from a state of being outside the virtual vehicle to a state of being inside the virtual vehicle is displayed in response to the trigger operation.

In this embodiment, when the second virtual character currently controlled by the first terminal meets the response trigger condition, the vehicle interaction control corresponding to the virtual vehicle is displayed at the designated position of the response message prompt option. After a trigger operation on the vehicle interaction control is received, the second virtual character switching from the state of being outside the virtual vehicle to the state of being inside the virtual vehicle is displayed.

That is, the vehicle interaction control is displayed at the designated position of the response message prompt option, so that the second virtual character can implement a riding process by triggering the vehicle interaction control without moving, which improves efficiency of human-computer interaction.

In summary, the method provided in this embodiment clarifies a process of determining the activation and effectiveness of the response message prompt option, provides the player with a quick response operation for the vehicle interaction prompt messages sent by other players, and enriches a gaming experience of the player.

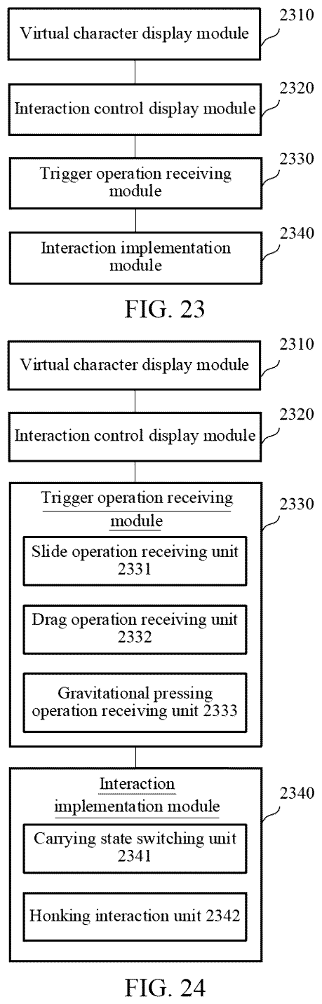

FIG. 23 is a structural block diagram of a vehicle interaction apparatus in a virtual scene according to an embodiment of this disclosure. As shown in FIG. 23, the apparatus includes the following parts:
a virtual character display module 2310, configured to display a first virtual character in the virtual scene, the first virtual character being a virtual character currently controlled by a first terminal, and the virtual scene further including a second virtual character;
an interaction control display module 2320, configured to display a vehicle interaction control in response to a vehicle interaction condition being met between the first virtual character and a virtual vehicle, the vehicle interaction control being configured for indicating the first virtual character to perform the first interaction action with the virtual vehicle;
a trigger operation receiving module 2330, configured to receive a trigger operation on the vehicle interaction control; and
an interaction implementation module 2340, configured to: in response to a trigger operation, transmit a vehicle interaction prompt message to the second virtual character, and display an animation of performing a first interaction action between the first virtual character and the virtual vehicle, the vehicle interaction prompt message being configured for prompting that a second interaction action is performed between the second virtual character and the virtual vehicle.

In an optional embodiment, as shown in FIG. 24,

the vehicle interaction condition includes a distance requirement between the first virtual character and the virtual vehicle, and the vehicle interaction control includes a state switching control, the state switching control being a control for switching a carrying state of the virtual vehicle; and the interaction implementation module 2340 includes a carrying state switching unit 2341, the carrying state switching unit being configured to: in response to the trigger operation, display an animation of the first virtual character switching from a first state of being outside the virtual vehicle to a second state of being inside the virtual vehicle, and transmit the vehicle interaction prompt message to the second virtual character.

In an optional embodiment, the carrying state switching unit 2341, configured to: in response to the trigger operation, display the first virtual character switching from the first state of being outside the virtual vehicle to a state of driving the virtual vehicle, and transmit the vehicle interaction prompt message to the second virtual character; or in response to the trigger operation, display the first virtual character switching from the first state of being outside the virtual vehicle to a state of riding in the virtual vehicle, and transmit the vehicle interaction prompt message to the second virtual character.

In an optional embodiment, the vehicle interaction condition includes a carrying requirement of the first virtual character on the virtual vehicle, and the vehicle interaction control includes a honking control; and the interaction implementation module 2340 includes a honking interaction unit 2342, the honking interaction unit 2342 being configured to: in response to the trigger operation, transmit the vehicle interaction prompt message to the second virtual character, display a honking trigger action of the first virtual character for the virtual vehicle, and express a honking effect of the virtual vehicle.

In an optional embodiment, the trigger operation receiving module 2330 includes a slide operation receiving unit 2331, a drag operation receiving unit 2332, or a gravitational pressing operation receiving unit 2333. The slide operation receiving unit 2331, configured to receive a slide operation on the vehicle interaction control, the slide operation being an operation of sliding the vehicle interaction control for a preset distance threshold. The drag operation receiving unit 2332, configured to receiving a drag operation on the vehicle interaction control, the drag operation being an operation of dragging the vehicle interaction control to a designated region range. The gravitational pressing operation receiving unit 2333, configured to receive a gravitational pressing operation on the vehicle interaction control.

In an optional embodiment, the message interaction control is further displayed in a terminal interface; and the drag operation receiving unit 2332, configured to receive a drag operation of dragging the vehicle interaction control to the designated region range, the designated region range being a preset region range comprising the message interaction control.

In an optional embodiment, the virtual scene includes a plurality of candidate virtual vehicles that meet the vehicle interaction condition with the first virtual character; the interaction control display module 2320, configured to display vehicle interaction controls respectively corresponding to the plurality of candidate virtual vehicles in response to the vehicle interaction condition being met between the first virtual character and the plurality of candidate virtual vehicles, the display of the vehicle interaction controls corresponding to an arrangement relationship of the plurality of candidate virtual vehicles in the virtual scene; and the trigger operation receiving module 2330, configured to receive a trigger operation on a vehicle interaction control corresponding to a designated virtual vehicle in the plurality of candidate virtual vehicles.

In an optional embodiment, the virtual scene includes a first virtual vehicle and a second virtual vehicle, the vehicle interaction condition being met between either of the first virtual vehicle and the second virtual vehicle and the first virtual character; the trigger operation receiving module 2330, configured to receive a trigger operation on a vehicle interaction control corresponding to the first virtual vehicle; and the interaction implementation module 2340, configured to: display, in a process of displaying the animation of performing the first interaction action between the first virtual character and the first virtual vehicle, in response to receiving a trigger operation on a vehicle interaction control corresponding to the second virtual vehicle, switching from a state of being inside the first virtual vehicle to a state of being inside the second virtual vehicle, and transmit the vehicle interaction prompt message corresponding to the second virtual vehicle to the second virtual character.

In an optional embodiment, the interaction implementation module 2340 is configured to: display a virtual character list, the virtual character list including character options respectively corresponding to the plurality of candidate virtual characters; receive a selection operation on a character option corresponding to a third virtual character in the plurality of candidate virtual characters; and in response to the selection operation, transmit the vehicle interaction prompt message to the third virtual character, and display an animation of performing the first interaction action between the first virtual character and the virtual vehicle.

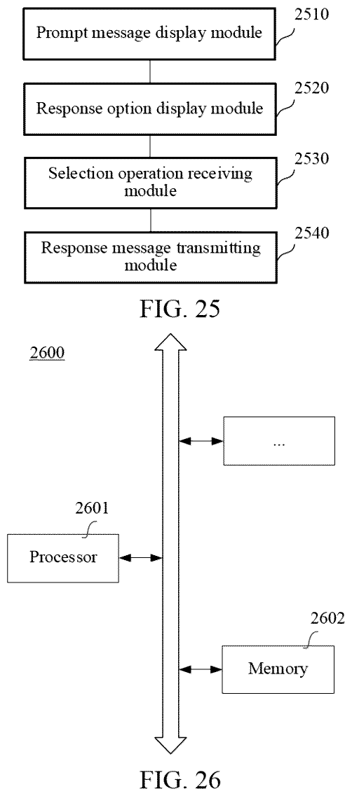

FIG. 25 is a structural block diagram of a vehicle interaction apparatus in a virtual scene according to an embodiment of this disclosure. As shown in FIG. 25, the apparatus includes the following parts:
a prompt message display module 2510, configured to display a vehicle interaction prompt message transmitted by a first virtual character in the virtual scene, the vehicle interaction prompt message being a message simultaneously sent when a first interaction action is performed between the first virtual character and the virtual vehicle through a vehicle interaction control;
a response option display module 2520, configured to display a response message prompt option in response to a second virtual character currently controlled by a first terminal meeting a response trigger condition;
a selection operation receiving module 2530, configured to receive a selection operation in the response message prompt option; and
a response message transmitting module 2540, configured to transmit a response message to the first virtual character in response to the selection operation, the response message being configured for responding to the vehicle interaction prompt message.

In an optional embodiment, a response option display module 2520, configured to display the response message prompt option in response to the second virtual character being outside the virtual vehicle when receiving the vehicle interaction prompt message transmitted by the first virtual character.

In an optional embodiment, the response option display module 2520, configured to hide the display of the response message prompt option in response to display duration of the response message prompt option reaching a preset duration threshold.

In an optional embodiment, the response option display module 2520, configured to: display the vehicle interaction control at a designated position of the response message prompt option in response to the second virtual character currently controlled by the first terminal meeting the response trigger condition; receive a trigger operation on the vehicle interaction control; and in response to the trigger operation, display the second virtual character switching from a state of being outside the virtual vehicle to a state of being inside the virtual vehicle.

The vehicle interaction apparatus in a virtual scene provided in the foregoing embodiments is merely illustrated with an example of division of each functional module. In actual application, the functions may be allocated to and completed by different functional modules according to requirements, that is, an internal structure of the device is divided into different functional modules, to implement all or some of the functions described above.

One or more modules, submodules, and/or units of the apparatus can be implemented by processing circuitry, software, or a combination thereof, for example. The term module (and other similar terms such as unit, submodule, etc.) in this disclosure may refer to a software module, a hardware module, or a combination thereof. A software module (e.g., computer program) may be developed using a computer programming language and stored in memory or non-transitory computer-readable medium. The software module stored in the memory or medium is executable by a processor to thereby cause the processor to perform the operations of the module. A hardware module may be implemented using processing circuitry, including at least one processor and/or memory. Each hardware module can be implemented using one or more processors (or processors and memory). Likewise, a processor (or processors and memory) can be used to implement one or more hardware modules. Moreover, each module can be part of an overall module that includes the functionalities of the module. Modules can be combined, integrated, separated, and/or duplicated to support various applications. Also, a function being performed at a particular module can be performed at one or more other modules and/or by one or more other devices instead of or in addition to the function performed at the particular module. Further, modules can be implemented across multiple devices and/or other components local or remote to one another. Additionally, modules can be moved from one device and added to another device, and/or can be included in both devices.

FIG. 26 is a structural block diagram of a computer device 2600 according to an embodiment of this disclosure. The computer device 2600 may be a smartphone, a tablet computer, a Moving Picture Experts Group Audio Layer III (MP3) player, a Moving Picture Experts Group Audio Layer IV (MP4) player, a notebook computer, or a desktop computer. The computer device 2600 may be further referred to as another name such as user equipment, a portable terminal, a laptop terminal, or a desktop terminal.

The computer device 2600 includes: a processor 2601 (i.e., processing circuitry) and a memory 2602 (i.e., a non-transitory computer-readable storage medium).

The processor 2601 may include one or more processing cores, such as a 4-core processor or an 8-core processor. The processor 2601 may be implemented by using at least one hardware form of a digital signal processor (DSP), a field-programmable gate array (FPGA), and a programmable logic array (PLA). The processor 2601 may also include a main processor and a coprocessor. The main processor is a processor configured to process data in an active state, also referred to as a central processing unit (CPU). The coprocessor is a low-power consumption processor configured to process data in a standby state. In some embodiments, the processor 2601 may be integrated with a graphics processing unit (GPU). The GPU is configured to be responsible for rendering and drawing content that needs to be displayed in a display. In some embodiments, the processor 2601 may also include an artificial intelligence (AI) processor. The AI processor is configured to process a computing operation related to machine learning.

The memory 2602 may include one or more computer-readable storage media. The computer-readable storage media may be non-transitory. The memory 2602 may also include a high-speed random access memory and a non-volatile memory, for example, one or more disk storage devices and flash storage devices. In some embodiments, the non-transitory computer-readable storage medium in the memory 2602 is configured to store at least one instruction. The at least one instruction is executed by the processor 2601 to perform the interaction method for the virtual object provided in the method embodiment in this disclosure.

In some embodiments, the computer device 2600 also include other components. A person skilled in the art may understand that the structure shown in FIG. 26 does not constitute a limitation to the computer device 2600, and the computer device may include more components or fewer components than those shown in the figure, or some components may be combined, or a different component deployment may be used.

In some embodiments, the computer-readable storage medium may include: a read only memory (ROM), a random access memory (RAM), a solid state drive (SSD), an optical disc, or the like. The RAM may include a resistance random access memory (ReRAM) and a dynamic random access memory (DRAM). The sequence numbers of the foregoing embodiments of this disclosure are merely for description purpose, and do not indicate the preference of the embodiments.

An embodiment of this disclosure further provides a computer device. The computer device may be implemented as the terminal or the server as shown in FIG. 3. The computer device includes a processor and a memory. The memory stores at least one instruction, at least one program, a code set, or an instruction set, the at least one instruction, the at least one program, the code set, or the instruction set being loaded and executed by a processor to implement the vehicle interaction method in a virtual scene according to the foregoing method embodiments.

An embodiment of this disclosure further provides a computer-readable storage medium. The computer-readable storage medium stores at least one instruction, at least one segment of program, a code set or an instruction set, the at least one instruction, the at least one segment of program, the code set or the instruction set being loaded and executed by the processor to implement the vehicle interaction method in a virtual scene according to the foregoing method embodiments.

An embodiment of this disclosure further provides a computer program product or a computer program. The computer program product or the computer program includes computer instructions, the computer instructions being stored in a computer-readable storage medium. A processor of a computer device reads the computer instructions from the computer-readable storage medium and executes the computer instructions to cause the computer device to perform the vehicle interaction method in a virtual scene according to any one of the foregoing embodiments.

In some embodiments, the computer-readable storage medium may include: a read only memory (ROM), a random access memory (RAM), a solid state drive (SSD), an optical disc, or the like. The RAM may include a resistance random access memory (ReRAM) and a dynamic random access memory (DRAM). The sequence numbers of the foregoing embodiments of this disclosure are merely for description purpose, and do not indicate the preference of the embodiments.

The use of “at least one of” or “one of” in the disclosure is intended to include any one or a combination of the recited elements. For example, references to at least one of A, B, or C; at least one of A, B, and C; at least one of A, B, and/or C; and at least one of A to C are intended to include only A, only B, only C or any combination thereof. References to one of A or B and one of A and B are intended to include A or B or (A and B). The use of “one of” does not preclude any combination of the recited elements when applicable, such as when the elements are not mutually exclusive.

The foregoing disclosure includes some exemplary embodiments of this disclosure which are not intended to limit the scope of this disclosure. Other embodiments shall also fall within the scope of this disclosure.

What is claimed is:

1. A vehicle interaction method, comprising:
displaying, by a first terminal, a first virtual character in a virtual scene, the first virtual character is a virtual character controlled by the first terminal, and the virtual scene includes a second virtual character;
displaying, by the first terminal, a vehicle interaction interface when a vehicle interaction condition is met between the first virtual character and a virtual vehicle; and
transmitting a vehicle interaction message to the second virtual character and displaying, by the first terminal, an animation of a first interaction between the first virtual character and the virtual vehicle in response to a vehicle trigger operation received by the first terminal on the vehicle interaction interface.

2. The method according to claim 1, wherein the vehicle interaction condition includes a distance requirement between the first virtual character and the virtual vehicle, and the vehicle interaction interface includes a state switching interface, the state switching interface is to switch a vehicle carrying state of the virtual vehicle; and
the method further comprises:
displaying a first animation of the first virtual character switching from a first state of being outside the virtual vehicle to a second state of being inside the virtual vehicle, and
transmitting the vehicle interaction message to the second virtual character in response to the vehicle trigger operation.

3. The method according to claim 2, further comprising one of:
in response to the vehicle trigger operation, displaying a second animation of the first virtual character switching from the first state of being outside the virtual vehicle to a state of driving the virtual vehicle, and transmitting the vehicle interaction message to the second virtual character; or
in response to the vehicle trigger operation, displaying a third animation of the first virtual character switching from the first state of being outside the virtual vehicle to a state of riding in the virtual vehicle, and transmitting the vehicle interaction message to the second virtual character.

4. The method according to claim 1, wherein the vehicle interaction condition includes a vehicle carrying requirement of the first virtual character on the virtual vehicle, and the vehicle interaction interface includes a horn control; and
the method further comprises:
transmitting the vehicle interaction message to the second virtual character;
displaying the horn control of the first virtual character for the virtual vehicle; and
expressing a honking effect of the virtual vehicle in response to the vehicle trigger operation.

5. The method according to claim 1, further comprising:
receiving the vehicle trigger operation on the vehicle interaction interface.

6. The method according to claim 5, wherein the receiving the vehicle trigger operation comprises:
receiving a slide operation on the vehicle interaction interface, the slide operation is an operation of sliding the vehicle interaction interface to a preset distance threshold; or
receiving a drag operation on the vehicle interaction interface, the drag operation is an operation of dragging the vehicle interaction interface to a designated region; or
receiving a gravitational pressing operation on the vehicle interaction interface.

7. The method according to claim 6, wherein a message interaction interface is displayed in a terminal interface; and the designated region is a preset region that includes the message interaction interface.

8. The method according to claim 1, wherein the virtual scene includes a plurality of candidate virtual vehicles that meet the vehicle interaction condition with the first virtual character; and
the method further comprises:
displaying the vehicle interaction interface respectively corresponding to each of the candidate virtual vehicles when the vehicle interaction condition is met, wherein the displaying of the vehicle interaction interface corresponds to an arrangement relationship of the candidate virtual vehicles in the virtual scene; and
receiving the vehicle trigger operation on the vehicle interaction interface corresponding to a designated virtual vehicle from the plurality of candidate virtual vehicles.

9. The method according to claim 8, wherein the virtual scene includes a first virtual vehicle and a second virtual vehicle, the vehicle interaction condition is met between either of the first virtual vehicle and the second virtual vehicle and the first virtual character; and
the method further comprises:
receiving the vehicle trigger operation on the vehicle interaction interface corresponding to the first virtual vehicle; and
in response to receiving the vehicle trigger operation on the vehicle interaction interface corresponding to the second virtual vehicle, displaying a fourth animation of the first virtual character switching from a state of being inside the first virtual vehicle to a state of being inside the second virtual vehicle, and transmitting the vehicle interaction message corresponding to the second virtual vehicle to the second virtual character.

10. The method according to claim 1, further comprising:
displaying a virtual character list, the virtual character list includes character options respectively corresponding to a plurality of candidate virtual characters;
receiving a character selection operation on one of the character options corresponding to a third virtual character in the plurality of candidate virtual characters; and
in response to the character selection operation, transmitting the vehicle interaction message to the third virtual character, and displaying the animation of the first interaction between the first virtual character and the virtual vehicle.

11. A data processing apparatus, comprising:
processing circuitry of a first terminal configured to:
display a first virtual character in a virtual scene, the first virtual character is a virtual character controlled by the first terminal, and the virtual scene includes a second virtual character;
display a vehicle interaction interface when a vehicle interaction condition is met between the first virtual character and a virtual vehicle; and
transmit a vehicle interaction message to the second virtual character and display an animation of a first interaction between the first virtual character and the virtual vehicle in response to a vehicle trigger operation received by the first terminal on the vehicle interaction interface.

12. The data processing apparatus according to claim 11, wherein the vehicle interaction condition includes a distance requirement between the first virtual character and the virtual vehicle, and the vehicle interaction interface includes a state switching interface, the state switching interface is to switch a vehicle carrying state of the virtual vehicle; and
wherein the processing circuitry of the first terminal is configured to:
display a first animation of the first virtual character switching from a first state of being outside the virtual vehicle to a second state of being inside the virtual vehicle, and
transmit the vehicle interaction message to the second virtual character in response to the vehicle trigger operation.

13. The data processing apparatus according to claim 12, wherein the processing circuitry of the first terminal is configured to perform:
in response to the vehicle trigger operation, display a second animation of the first virtual character switching from the first state of being outside the virtual vehicle to a state of driving the virtual vehicle, and transmitting the vehicle interaction message to the second virtual character; or
in response to the vehicle trigger operation, display a third animation of the first virtual character switching from the first state of being outside the virtual vehicle to a state of riding in the virtual vehicle, and transmitting the vehicle interaction message to the second virtual character.

14. The data processing apparatus according to claim 11, wherein the vehicle interaction condition includes a vehicle carrying requirement of the first virtual character on the virtual vehicle, and the vehicle interaction interface includes a horn control; and
wherein the processing circuitry of the first terminal is configured to:
transmit the vehicle interaction message to the second virtual character;
display the horn control of the first virtual character for the virtual vehicle; and
express a honking effect of the virtual vehicle in response to the vehicle trigger operation.

15. The data processing apparatus according to claim 11, wherein the processing circuitry of the first terminal is configured to:
receive the vehicle trigger operation on the vehicle interaction interface.

16. The data processing apparatus according to claim 15, wherein the processing circuitry of the first terminal is configured to:
receive a slide operation on the vehicle interaction interface, the slide operation is an operation of sliding the vehicle interaction interface to a preset distance threshold; or
receive a drag operation on the vehicle interaction interface, the drag operation is an operation of dragging the vehicle interaction interface to a designated region; or
receive a gravitational pressing operation on the vehicle interaction interface.

17. The data processing apparatus according to claim 16, wherein a message interaction interface is displayed in a terminal interface; and the designated region is a preset region that includes the message interaction interface.

18. The data processing apparatus according to claim 11, wherein the virtual scene includes a plurality of candidate virtual vehicles that meet the vehicle interaction condition with the first virtual character; and
display the vehicle interaction interface respectively corresponding to each of the candidate virtual vehicles when the vehicle interaction condition is met, wherein the displaying of the vehicle interaction interface corresponds to an arrangement relationship of the candidate virtual vehicles in the virtual scene; and
receive the vehicle trigger operation on the vehicle interaction interface corresponding to a designated virtual vehicle from the plurality of candidate virtual vehicles.

19. The data processing apparatus according to claim 11, wherein the processing circuitry of the first terminal is configured to:
display a virtual character list, the virtual character list includes character options respectively corresponding to a plurality of candidate virtual characters;
receive a character selection operation on one of the character options corresponding to a third virtual character in the plurality of candidate virtual characters; and
in response to the character selection operation, transmit the vehicle interaction message to the third virtual character, and displaying the animation of the first interaction between the first virtual character and the virtual vehicle.

20. A non-transitory computer-readable storage medium storing instructions which, when executed by a processor of a first terminal, cause the processor of the first terminal to perform:
displaying a first virtual character in a virtual scene, the first virtual character is a virtual character controlled by the first terminal, and the virtual scene includes a second virtual character;
displaying a vehicle interaction interface when a vehicle interaction condition is met between the first virtual character and a virtual vehicle; and
transmitting a vehicle interaction message to the second virtual character and displaying an animation of a first interaction between the first virtual character and the virtual vehicle in response to a vehicle trigger operation received by the first terminal on the vehicle interaction interface.
